(19) United States
(12) Patent Application Publication
(10) Pub. No.: US 2015/0324872 A1
(43) Pub. Date: Nov. 12, 2015

(54) Matching Data From Various Channels

(71) Applicant: BANK OF AMERICA CORPORATION, Charlotte, NC (US)

(72) Inventors: Manish Daswani, Mumbai (IN); Piers Element, Lantau Island (HK); Ka Yee Catherine Li, Causeway Bay (HK); Edward Rose, Willoughby NSW (AU); Toh Hean Tan, Nee Soon (SG)

(73) Assignee: BANK OF AMERICA CORPORATION, Charlotte, NC (US)

(21) Appl. No.: 14/273,705

(22) Filed: May 9, 2014

(51) Int. Cl. G06Q 30/04; G06F 17/30

(52) U.S. Cl. CPC G06Q 30/04; G06F 17/30864

(57) ABSTRACT

Systems, methods and apparatuses for receiving payment information via a first channel and receiving additional information via a second channel are provided. In some examples, a determination may be made as to whether the received payment information matches the received additional information. If so, the payment and additional information may be associated and used to identify an associated outstanding invoice. If not, a determination may be made as to whether a potential match exists. If so, additional processing may occur to determine whether the potential match is an actual match.

### BACKGROUND

Entities, such as corporations, and the like, often have accounts receivables departments processing hundreds or possibly thousands of invoices. Often, payments are received by the entity but the payment does not include sufficient information to identify the payor or the invoice to which the payment should be applied. In some conventional systems, additional information may be provided to the entity, separate from the payment, that includes information such as invoice number, payor identification, and the like. However, because that information is received separately from the payment, and often via a different channel than the payment was received, matching the payment with the associated received additional information and/or the associated open invoice can be complicated, inefficient and error-prone.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems, and apparatuses for identifying and associating payment(s) received with one or more open invoices. In some examples, the payment may be received via a first channel and may include insufficient information to identify the invoice to which the payment should be applied. Additional information regarding the payment may be received via a second, different channel (such as email, fax, or the like) and may include information sufficient to identify the invoice. Accordingly, the received payment should be matched to the corresponding received additional information in order to identify the outstanding invoice, apply payment to the invoice and close out the invoice.

In some examples, instead of or in addition to the additional information received, a listing of open invoices may be matched to the received payment(s) in order to accurately associate payment with the appropriate invoice and close out that invoice.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example invoice matching system according to one or more aspects described herein.

FIG. 4 is an example method of matching payments received with additional information in order to identify an associated payor and/or invoice according to one or more aspects described herein.

FIG. 5 is an example method of matching payments received to open invoices according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

As discussed above, payments are often received by entities without sufficient information to identify the invoice to which the payment should be applied. Accordingly, arrangements described herein are directed to matching a received payment with received additional information in order to identify an associated open invoice. Determination of whether a match occurs or the criteria for a match is met may be based on one or more business rules that may be customizable by the entity implementing the system. If the criteria for a match is not met, in some examples, a determination of whether a potential match exists may be made based on one or more additional business rules. Accordingly, the system may efficiently and accurately match payments received via channels different from the additional information with open invoices in order to efficiently process and close out the invoices. These and other arrangements will be discussed more fully below.

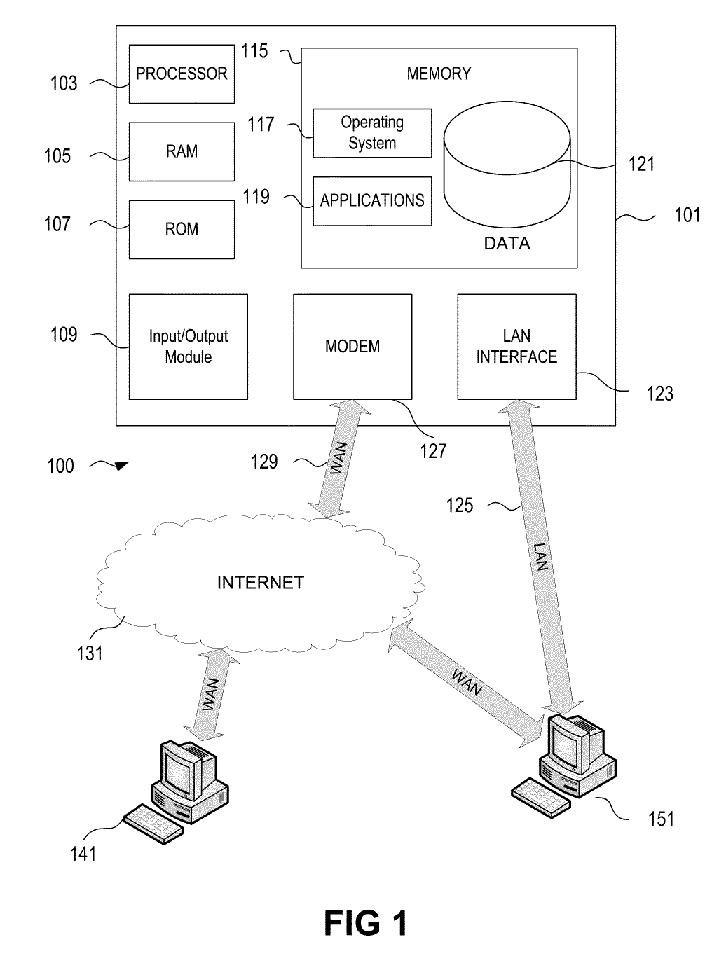

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

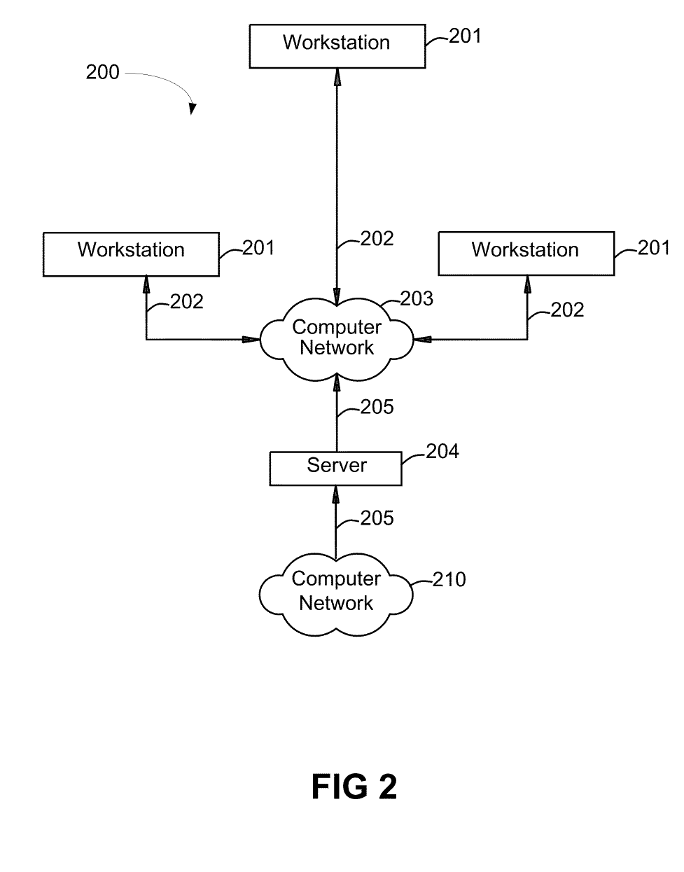

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

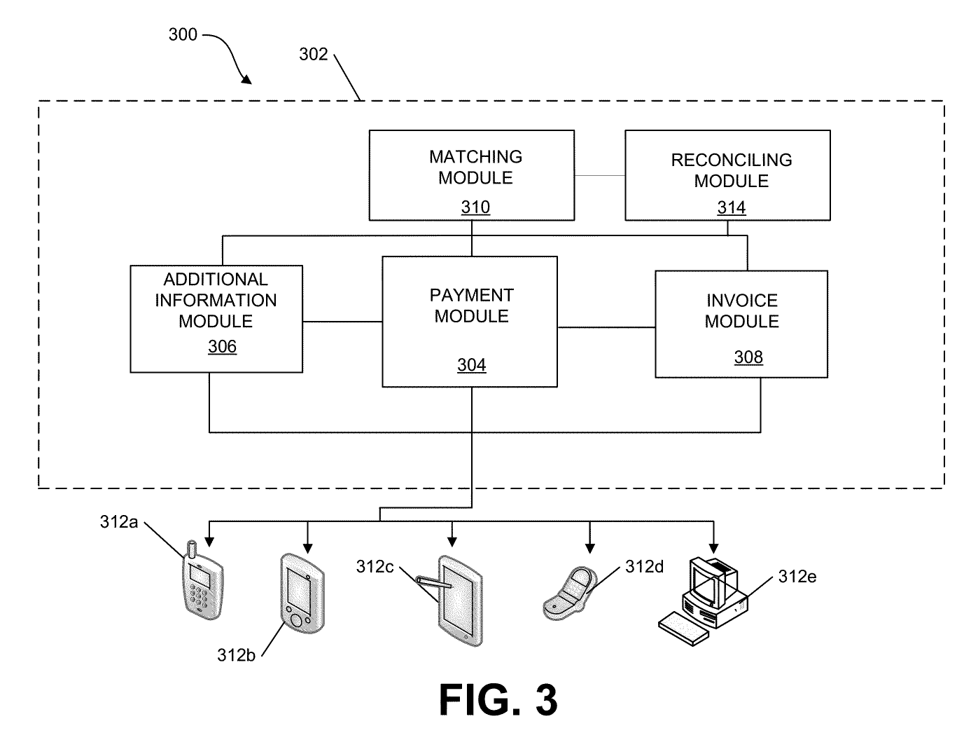

FIG. 3 illustrates one example invoice matching system 300 according to one or more aspects described herein. In some examples, the invoice matching system 300 may be part of, internal to or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the invoice matching system to use within a financial institution. Rather, the system may be implemented by various other types of entities.

The invoice matching system 300 may include one or more modules that may include hardware and/or software configured to perform various functions within the system 300. For instance, each module may include one or more aspects of computing device 101 in FIG. 1 or computing system environment 100 in FIG. 1.

The invoice matching system 300 may include a one or more modules configured to receive and/or store information. In some examples, the modules may be connected to or in communication with each other. One or more modules may be contained within a separate, physical computing device. In some examples, one or more modules may be contained within a single physical device, such as a computing device. Further, in some examples, each module may be connected to or in communication with one or more computing devices, such as computing devices 312a-312e, as will be discussed more fully below.

The invoice matching system 300 may include a payment module 304. The payment module 304 may generally receive and/or store information associated with a payment received. In some examples, the payment may be received in response to an outstanding invoice, e.g., for products or services provided. The payment module 304 may receive payments from a variety of channels. For instance, payments may be received via electronic funds transfer, wire transfer, check, a lock box type arrangement in which a check or payment is deposited in a secure container, and the like. Various other channels may be used for payment without departing from the invention.

In some arrangements, the payment received by the payment module 304 may include very little, if any, identifying information associated with the payor. This may make it difficult to identify the payor and ultimately reconcile the outstanding invoice. For instance, a check may include only a corporation name and amount. This information may be insufficient to determine the invoice associated with the payment, or determine who the particular payor is, which may make is difficult to reconcile the invoice.

Accordingly, in some examples, additional information may be received by the system, such as via additional information module 306. The additional information module 306 may receive information, separate from the payment and/or payment information, that provides additional information associated with the payor, invoice to which the payment should be applied, and the like. In some examples, the additional information may be received by the additional information module 306 via a free format email (e.g., the payor may email the payee and indicate that a payment was transmitted for X amount and should be applied to invoice Y). Additional information may also be received via facsimile, website or web portal, or the like.

In some examples, this received additional information may be matched to the received payment, such as via a matching module 310. The matching module 310 may communicate with the payment module 304 and additional information module 306 to determine whether a match exists between received additional information and a received payment. Matching may be determined based on an amount of payment matching an amount indicated in the additional information, a combination of amount received and payor information associated with the payment received matching the amount and payor identified in the additional information, and the like. Various other criteria may be used to match a payment to additional information without departing from the invention.

Criteria for identifying a match may be based on one or more business rules. In some examples, the business rules may be customizable and may be determined by the entity implementing the system, such as entity 302. For instance, one example business rule may provide a threshold for determining a match. For example, if the received payment amount is within a predetermined number of monetary units of the amount indicated in the additional information, a match may be identified. For instance, if the payment received is within five cents of the amount indicated in the additional information, a match may be identified between that payment and additional information.

In some examples, if the payment does not meet the predefined threshold for matching the additional information, the payment and additional information may be identified as a potential match. A potential match flag may indicate that the payment and additional information meet some criteria for a match but not all, or are outside of a threshold but still exhibit some matching criteria (e.g., outside the threshold difference in payment amount but from the same payor, or the like).

The invoice matching system 300 may further include an invoice module 308. The invoice module 308 may receive and/or store one or more open invoices. For instance, the invoice module 308 may store a data file or other listing of open invoices. Each open invoice may include information such as name or identifier of the person or entity to whom the invoice was issued, amount of invoice, invoice number or other identifier, date of invoice, and the like. In some examples, the matching module 310 may attempt to match one or more received payment with one or more outstanding invoices in the invoice module 308. Similar to the matching arrangement described above, the criteria for identifying a match may be based on one or more business rules and may provide a threshold for identifying a match. If the criteria for identifying a match are not met, a potential match may be identified between the payment and invoice.

If a match is identified, the payment may be associated with the additional information and/or outstanding invoice and the invoice may be reconciled, such as by the reconciling module 314. The reconciling module 314 may receive the matching payment and associated information and/or open invoice and may close out the outstanding invoice based on the determination that the payment matches the additional information and/or outstanding invoice. In some examples, this may be performed automatically. Accordingly, the system may efficiently close out outstanding invoices in order to reduce the number of days outstanding of an invoice, which is an important metric in accounts receivables.

These and various other arrangements will be discussed more fully below.

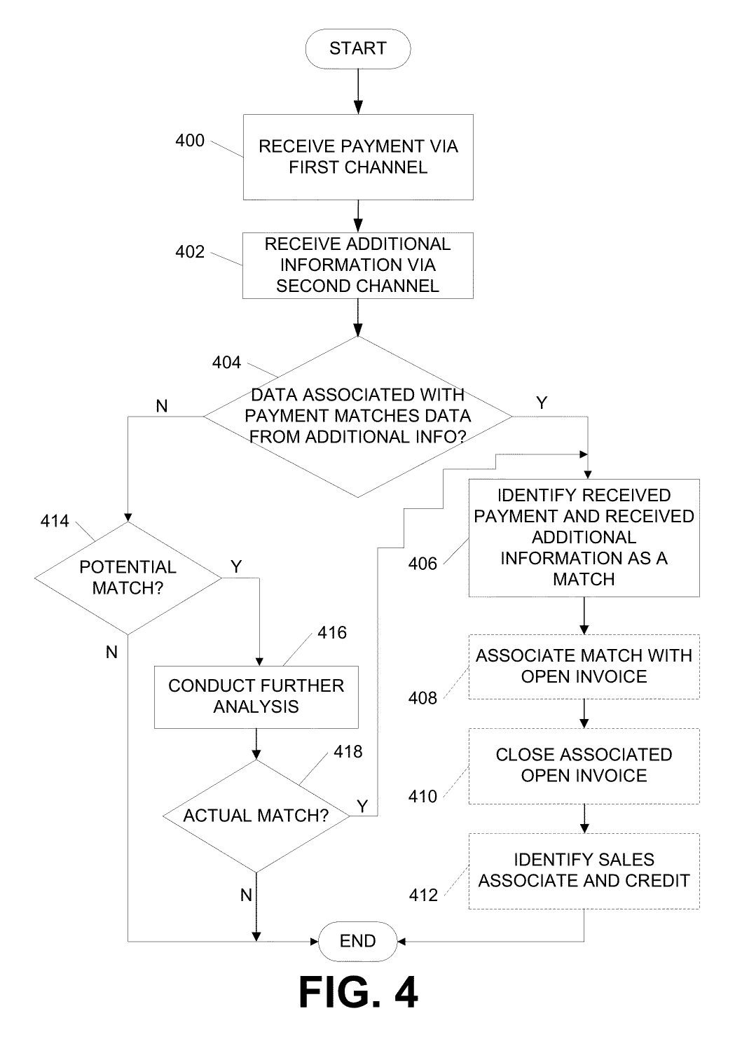

FIG. 4 illustrates one example method of matching payments received with additional information in order to identify an associated payor and/or invoice. In step 400, a payment is received via a first channel. The payment may be received via one of any of a plurality of channels. For instance, the payment may be received via wire transfer, electronic funds transfer, check, check or other payment device provided in secure location such as a lockbox, remote deposit (e.g., scanning a check and transmitting the image), and the like. The payment may include an amount and, in some examples, may include a name or other identifier of a payor. However, in many instances, this information is insufficient to identify an outstanding invoice to which the payment should be applied. For example, the payment might not include an invoice number to identify an invoice to which the payment should be applied. Further, the payor name may be a common name or may be the name of a large corporation with several open invoices. Accordingly, the invoice to which the payment should be applied may be unclear based on the payment information alone.

In step 402, additional information may be received via a second channel. The additional information may include additional information associated with the payment, such as an invoice number to which the payment should be applied, identifier of the payor, amount of payment, as well as any other information associated with the payment (e.g., identification of a credit on the account, reason for discrepancy between the payment amount and the invoice amount, and the like). The additional information may be received via a second channel different from the first channel. For instance, the additional information may be received via a free-from email, fax, or other channel. Accordingly, because the additional information associated with the payment and the payment itself are received via separate channels, a matching process is performed to associate the received payment with the received additional information in order to identify the appropriate invoice and close out the invoice. In conventional systems, this is a manual process that can be time consuming, prone to errors, and can result in delays in closing out invoices. However, the system described herein can efficiently match received payments with received additional information (or received invoice information as will be discussed more fully below) to efficiently identify invoices associated with payments and close out the invoices, thereby reducing the number of days outstanding for open invoices.

In step 404, a determination is made as to whether data associated with the received payment (e.g., amount of payment, and the like) matches data received from the additional information. In some arrangements, intelligent character recognition, optical character recognition, or the like, may be used to identify one or more pieces of data in the additional information received. Accordingly, an attempt may be made to match this data to data associated with the payment. A match may be identified when, for instance, an amount of payment matches an amount indicated in the additional information or is within a predefined threshold of the amount indicated in the additional information. In some examples, the predefined threshold may be one of a plurality of business rules implemented by the system. The business rules may be customizable by the entity implementing the system and may define, for instance, the threshold within which two amounts are considered to be a match.

If, in step 404, a determination is made that the payment received matches the additional information, in step 406 the payment and additional information may be identified or flagged as a match. In optional step 408, the payment may be associated with the additional information and with an open invoice identified based on the information contained in the matching payment and additional information (e.g., invoice number, or the like). In optional step 410, the associated open invoice may be closed.

In some example arrangements, additional processing may occur. For instance, in optional step 412, a sales associate associated with the received payment and/or closed invoice may be identified. A credit may be given to that sales associate for having a received payment and/or closed invoice. Accordingly, data associated with various sales associates may be tracked in order to follow performance of the sales associates. This is merely one example of additional processing or tracking of data that may be provided. Various other data may be further processed without departing from the invention.

If, in step 404, a determination is made that a match does not exist between the received payment and the received additional information (e.g., the data of the payment is not within the predetermined threshold for a match with the data from the additional information), in step 414, a determination may be made as to whether the received payment is a potential match with the received additional information. For instance, although the received payment may not meet the threshold for a match, additional business rules may identify other thresholds within which the payment and the additional information may be a potential match. A potential match indicates that the threshold for a match was not met but that there is still a potential that the payment and additional information are associated or apply to the same invoice.

For instance, if a payment is received for $100.65 and the payment information on the additional information indicates a payment of $100.56, a match might not exist because the $0.09 difference may be outside of the matching threshold (in this example). However, the system may identify the payment and additional information as a potential match because the amounts are close enough to be within a second threshold of each other (such as a second threshold defined by one or more business rules), or because two digits have been transposed, or because other identifying information is similar (e.g., payor name, and the like).

If a potential match is identified in step 414, additional processing and/or analysis may be performed to determine whether a match exists in step 416. Further analysis may, in some examples, include manual and or automated review of the payment data, additional information and associated data, and the like. In step 418, a determination is made as to whether, based on the additional analysis, an actual match exists. If so, the process will continue at step 406. If not, the process may end.

If, in step 414, a potential match is not identified (e.g., the payment and additional information do not meet criteria established by one or more business rules for a potential match), the process may end.

Although various arrangements described herein are described in terms of receipt of a payment and additional information, the systems, methods and arrangements described herein are configured to process multiple payments received and multiple pieces of additional information in order to identify associated invoices.

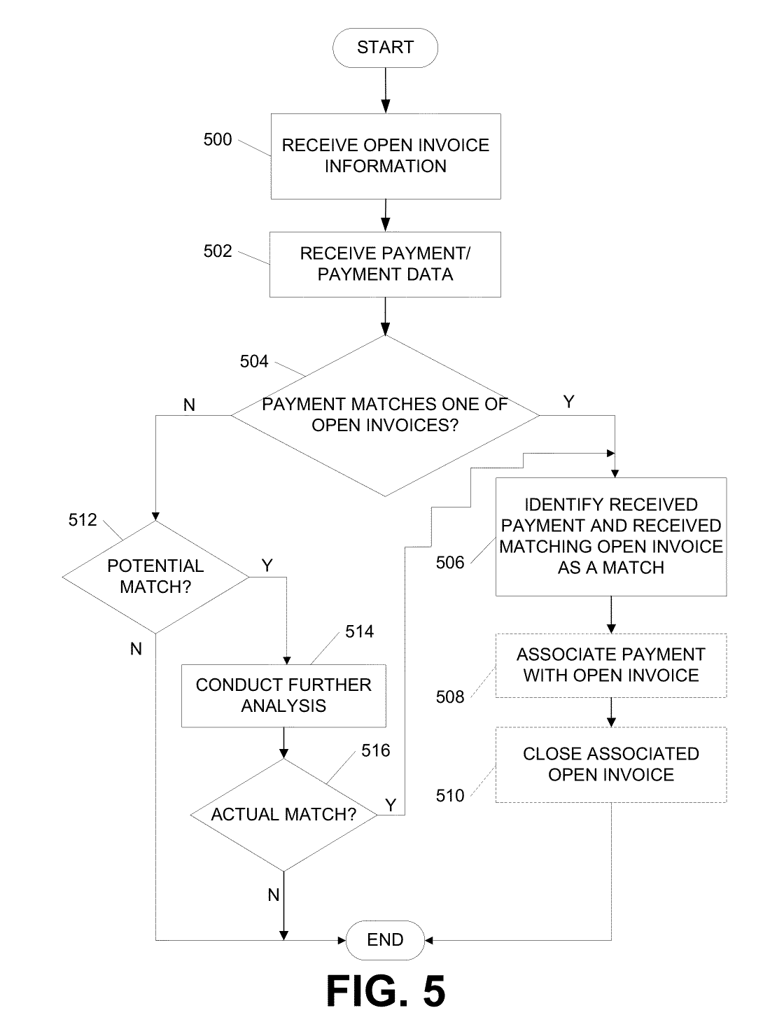

FIG. 5 illustrates another example method of matching payments received to open invoices according to one or more aspects described herein. In step 500, data associated with one or more open invoices may be received. In some examples, the data may be in the form of a data file identifying several or all open invoices for an entity. The open invoices may each include an invoice number or other identifier, amount of the invoice, identification of the person or entity to whom the invoice was issued, and the like. In step 502, payment information may be received. The payment information may be received via channels similar to those described with respect to step 400 in FIG. 4 and may include similar information or payment data.

In step 504, a determination is made as to whether the received payment matches an open invoice of the received open invoices. Similar to arrangements described above, a match may be identified when one or more pieces of data match or are within a predefined threshold of each other. Similar to other arrangements described herein, the matching criteria may be based on one or more business rules that may be customizable by the entity implementing the system.

If, in step 504, a determination is made that a match exists, the identified payment and associated open invoice may be identified or flagged as a match in step 506. In optional step 508, the payment and invoice may be associated and in step 510 the open invoice may be closed. Additional processing may also occur, similar to the arrangements discussed above.

If, in step 504, a determination is made that a match does not exist, in step 512 a determination may be made as to whether a potential match exists. This determination may be similar to the determination made in step 414 in FIG. 4 and may be based on one or more business rules. If a potential match does not exist in step 512, the process may end.

If, in step 512, a potential match does exist, additional analysis and or processing may be performed in step 514. The further analysis may be similar to that performed in step 416 in FIG. 4. In step 516, a determination may be made as to whether the potential match is an actual match based on the further analysis. If so, the process may continue at step 506. If not, the process may end.

The systems and processes described herein provide an efficient system for matching received payments with received additional information and/or outstanding invoices. The systems and methods described herein can aid in quickly closing out outstanding invoices in order to reduce the number of days outstanding associated with an invoice. The systems and methods may also provide an accurate system for automatically matching received payments with received additional information and/or open invoices, and/or identifying potential matches between received data items, as discussed above.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive a payment for an outstanding debt via a first channel, the payment including first data;
receive information associated with the payment, the information associated with the payment including second data and being received via a second channel different from the first channel;
determine whether at least a portion of the first data of the received payment matches at least a portion of the second data of the received information associated with the payment;
responsive to determining that at least a portion of the first data of the received payment matches at least a portion of the second data of the received information associated with the payment, identifying a match between the received payment and the received information associated with the payment; and
responsive to determining that at least a portion of the first data of the received payment does not match at least a portion of the second data of the received information associated with the payment, identifying a potential match between the received payment and the received information associated with the payment.

2. The apparatus of claim 1, wherein the first data includes at least one of a payment amount and a payor identifier.

3. The apparatus of claim 1, wherein the second data includes at least one of a payment amount, payor identifier, invoice number, date, and comments.

4. The apparatus of claim 1, wherein determining whether at least a portion of the first data of the received payment matches at least a portion of the second data of the received information associated with the payment further includes applying at least a first business rule identifying criteria for identifying a match.

5. The apparatus of claim 4, wherein determining whether at least a portion of the first data of the received payment matches at least a portion of the second data of the received information associated with the payment further includes applying at least a second business rule identifying criteria for identifying a potential match.

6. The apparatus of claim 1, wherein the first channel is one of an electronic funds transfer, wire transfer, image of a check and physical check.

7. The apparatus of claim 6, wherein the second channel is one of email and fax.

8. The apparatus of claim 7, wherein the received information associated with the payment is received in one of an email and fax and the computer-readable instructions, when executed, further cause the apparatus to:
perform intelligent character recognition on the at least one of an email and fax to identify the second data.

9. An apparatus, comprising:
at least one processor; and
a memory storing computer-readable instructions that, when executed by the at least one processor, cause the apparatus to:
receive first data identifying a plurality of open invoices associated with an entity, the first data including information associated with each open invoice of the plurality of open invoices;
receive a payment for an outstanding debt, the payment including second data;
determine whether at least a portion of the first data of the open invoices matches at least a portion of the second data of the received payment;
responsive to determining that the at least a portion of the first data of the open invoices matches the at least a portion of the second data of the received payment, identifying a match between the open invoice of the plurality of invoices associated with the at least a portion of the first data and the received payment; and
responsive to determining that the at least a portion of the first data of the open invoices does not match the at least a portion of the second data of the received payment, identifying a potential match between the open invoice of the plurality of invoices associated with the at least a portion of the first data and the received payment.

10. The apparatus of claim 9, further including instructions that, when executed, cause the apparatus to, responsive to identifying the match, close the open invoice of the plurality of invoices associated with the at least a portion of the first data identified as a match with the received payment.

11. The apparatus of claim 9, further including instructions that, when executed, cause the apparatus to:
responsive to identifying the match, identify a sales associate associated with the open invoice of the plurality of invoices associated with the at least a portion of the first data and identified as a match with the received payment;
provide credit for the received payment to the identified sales associate.

12. The apparatus of claim 9, wherein the second data includes at least one of a payment amount and a payor identifier.

13. The apparatus of claim 9, wherein determining whether at least a portion of the first data of the open invoices matches at least a portion of the second data of the received payment further includes applying at least a first business rule identifying criteria for identifying a match.

14. The apparatus of claim 13, wherein determining whether at least a portion of the first data of the open invoices matches at least a portion of the second data of the received payment further includes applying at least a second business rule identifying criteria for identifying a potential match.

15. A method, comprising:
receiving a payment for an outstanding debt via a first channel, the payment including first data;
receiving information associated with the payment, the information associated with the payment including second data and being received via a second channel different from the first channel;
determining whether at least a portion of the first data of the received payment matches at least a portion of the second data of the received information associated with the payment;
responsive to determining that at least a portion of the first data of the received payment matches at least a portion of the second data of the received information associated with the payment, identifying a match between the received payment and the received information associated with the payment; and
responsive to determining that at least a portion of the first data of the received payment does not match at least a portion of the second data of the received information associated with the payment, identifying a potential match between the received payment and the received information associated with the payment.

16. The method of claim 15, wherein the first data includes at least one of a payment amount and a payor identifier.

17. The method of claim 15, wherein the second data includes at least one of a payment amount, payor identifier, invoice number, date, and comments.

18. The method of claim 15, wherein determining whether at least a portion of the first data of the received payment matches at least a portion of the second data of the received information associated with the payment further includes applying at least a first business rule identifying criteria for identifying a match.

19. The method of claim 18, wherein determining whether at least a portion of the first data of the received payment matches at least a portion of the second data of the received information associated with the payment further includes applying at least a second business rule identifying criteria for identifying a potential match.

20. The method of claim 15, wherein the second channel is one of email and fax and further including performing intelligent character recognition on the at least one of an email and fax to identify the second data.
